(19) United States
(12) Patent Application Publication
(10) Pub. No.: US 2006/0165861 A1
(43) Pub. Date: Jul. 27, 2006

(54) Method of kneading an olive paste

(76) Inventor: David Picci, Florence (IT)

Correspondence Address: BRIGGS AND MORGAN P.A., 2200 IDS CENTER, 80 SOUTH 8TH ST, MINNEAPOLIS, MN, 55402, US

(21) Appl. No.: 11/043,820

(22) Filed: Jan. 26, 2005

(51) Int. Cl. A01J 25/00

(52) U.S. Cl. 426/519

(57) ABSTRACT

The invention relates to a method of kneading an olive paste in a vat (2) containing the olive phase and a gaseous phase, the method comprising:
a stage of filling the vat (2) with the olive paste;
a stage of kneading the paste in the vat (2), the method being characterized in that it comprises a stage of maintaining the oxygen content of the gaseous phase at a predetermined value.

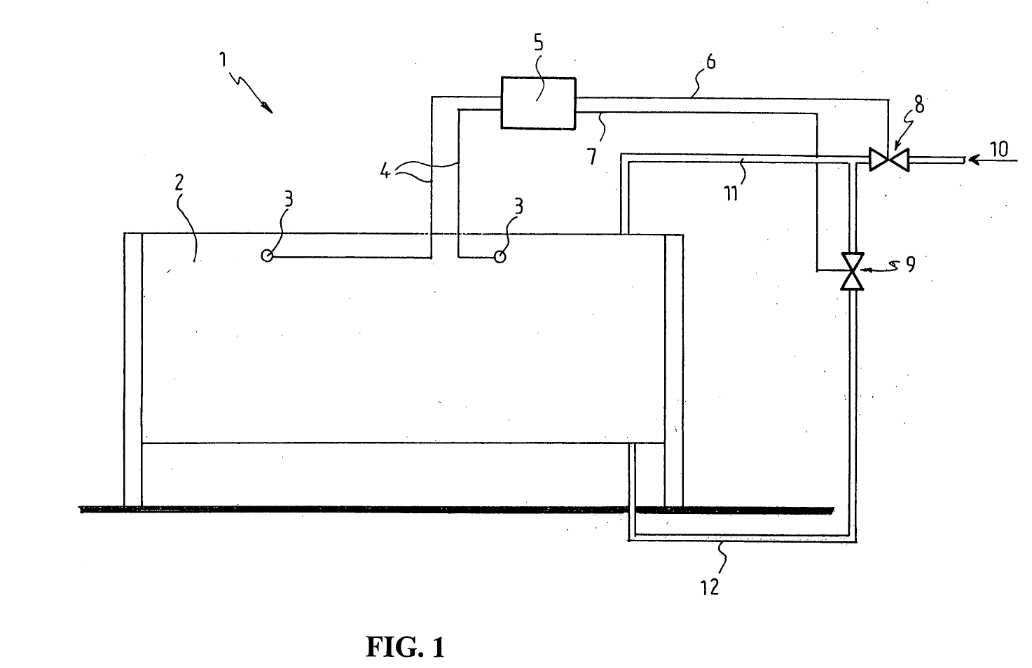

### BACKGROUND OF THE INVENTION

The invention relates to a kneading method for an olive paste. The invention also relates to a kneading device for carrying out such a method. The invention also relates to an olive paste obtained by such a method. It is used in the field of olive oil production.

Olive oil production comprises various stages: harvesting the olives, washing the olives and crushing the olives to obtain a paste, which is then kneaded to concentrate the drops of oil present in the solid matter. This kneading causes the oil drops to merge, so creating larger drops which are easier to extract from the solid matter and also promoting breaking up of the oil/water emulsion. This extraction then takes place by separation of the liquid from the solid matter, generally by pressing or decanting. After recovery of the liquid, which contains water and oil, these two elements are separated by centrifugation or decanting.

Kneading is performed in vats in which extraction screws rotate, so allowing kneading of the olive paste. Kneading takes 30 to 40 minutes.

The olive oil contains polyphenolic products and tocopherols, the proportions of which vary depending on the type of olive and its maturity, the level of polyphenolic products being higher the less mature is the olive.

These polyphenolic products and tocopherols are all the more important since they are very significant antioxidants from the point of view of health.

The presence of oxygen during kneading causes oxidation of the polyphenolic products and the tocopherols in the olive oil, which results in a reduction in their proportions in the oil, a reduction in the shelf life of the oil and impairment of the flavour of the oil.

Anaerobic kneading is already known which makes it possible to reduce the oxidation of the polyphenolic products and the tocopherols in the oil.

During kneading, enzymes increase the extraction yield and accelerate extraction of the oil, the polyphenolic products and the tocopherols present in the paste, in particular breaking open the olives' cells which thus release oil. The enzymes require oxygen to act, so anaerobic kneading is not desirable.

The problem is thus to implement a method of kneading an olive paste which allows the use of oxygen to allow the enzymes to act while avoiding oxidation of the polyphenolic products and the tocopherols in the oil by oxygen.

### SUMMARY OF THE INVENTION

An object of the present invention is to propose a kneading method for an olive paste which does not exhibit the disadvantages of the prior art.

To this end, a method is proposed for kneading an olive paste in a vat containing the olive paste and a gaseous phase, the method comprising a stage of filling the vat with the olive paste and a stage of kneading the paste in the vat, the method being characterized in that it comprises a stage of maintaining the oxygen content of the gaseous phase at a predetermined value.

Advantageously, the stage of maintaining the oxygen content at the predetermined value is effected by injection of an inert gas or a mixture to inert gases.

Advantageously, the stage of maintaining the oxygen content at the predetermined value is effected by injection of oxygen.

Advantageously, injection of the inert gas and/or the oxygen is effected via the upper part of the vat.

Advantageously, the method comprises a stage of filling the vat with a gas until a gaseous phase is obtained in accordance with the predetermined value prior to the stage of filling the vat with the olive paste.

Advantageously, the stage of filling the vat with a gas is effected via the lower part of the vat.

Advantageously, monitoring the oxygen content in the vat during the stage of filling the vat with a gas until a gaseous phase is obtained in accordance with the predetermined value and the stage of maintaining the oxygen content at the predetermined value is performed by a control unit which controls opening or closing of valves for supplying gas to the vat as a function of the data which it receives from probes for detecting the concentration of oxygen in the vat.

Advantageously, the predetermined value is between 6% and 12%.

Advantageously, the predetermined value is 6%.

The invention also proposes a kneading device for an olive paste suitable for carrying out a kneading method according to one of the above variants, comprising a vat containing the paste to be kneaded and a gaseous phase, the device being characterized in that it comprises: at least one oxygen concentration detecting probe for measuring the oxygen concentration in the gaseous phase in the vat; at least one gas supply pipe for supplying the vat with gas; a control unit suitable for authorising or preventing the supply of gas to the vat as a function of the data which it receives from probes for detecting the concentration of oxygen in the vat.

Advantageously, the device comprises a supply pipe situated at the upper part of the vat and suitable for supplying the vat with gas to maintain the oxygen content at the predetermined value.

Advantageously, the device comprises a supply pipe situated at the lower part of the vat and suitable for filling the vat with a gas.

Advantageously, the gas is an inert gas or a mixture of inert gases.

Advantageously the gas comprises oxygen.

According to a first embodiment, the vat is airtight.

According to a second embodiment, the vat is not airtight.

The invention also proposes an olive paste characterized in that it is obtained according to the method of one of the above variants.

The features of the invention mentioned above, as well as others, will become clearer from a reading of the following description of an exemplary embodiment, said description being made with relation to the single FIGURE, which represents a kneading device according to the invention.

### BRIEF DESCRIPTION OF THE DRAWINGS

The single FIG. illustrates a kneading device 1, comprising a vat 2, which may be generally cylindrical in shape, in which there is mounted a kneading screw. By rotation thereof, the screw causes the release of drops of oil trapped in the paste and the merging thereof in larger drops.

### DETAILED DESCRIPTION

Conventionally, the vat 2 comprises devices for introducing the paste into the vat 2 and recovering the kneaded paste. The vat 2 is filled with the paste to be kneaded and a gaseous phase.

The kneading device 1 comprises at least one oxygen content detecting probe 3, which makes it possible to measure the oxygen concentration inside the vat 2. In order to measure the oxygen concentration in the entire vat 2, a plurality of oxygen concentration detecting probes 3 are distributed in the vat 2. As the paste is located in the lower part of the vat 2 and the gaseous phase is located in the upper part of the vat 2, the oxygen concentration detecting probes 3 will advantageously be positioned in the upper part of the vat 2.

The oxygen concentration detecting probes 3 are connected via connecting wires 4 to a control unit 5.

The vat 2 comprises an upper supply pipe 11 and a lower supply pipe 12. These pipes make it possible to supply the vat 2 with gas. The upper supply pipe 11 is situated at the upper part of the vat 2. The lower supply pipe 12 is situated at the lower part of the vat 2.

The gas is stored in a tank (not shown) and arrives via a gas inlet device 10 connected to the supply pipes 11, 12.

The general inlet of gas into the upper supply pipe 11 and the lower supply pipe 12 is controlled by a general supply valve 8.

Inlet of the gas into the lower supply pipe 12 is also controlled by a lower supply valve 9.

The general supply valve 8 is controlled by the control unit 5, by means of a general supply control cable 6.

The lower supply valve 9 may be controlled manually or by the control unit 5, by means of a lower supply control cable 7.

In order to avoid oxidation of the polyphenolic products and the tocopherols in the oil during kneading, the vat 2 is filled with an inert gas, while retaining an oxygen concentration which is sufficient for the enzymes to act. The inert gas may be argon, nitrogen or any other gas which prevents oxidation and which is compatible with food use.

If the vat 2 is not airtight, the oxygen comes from the ambient air and if the oxygen content is greater than the predetermined content, the inert gas will then be selected to lower the oxygen content in the vat 2.

If the vat 2 is not airtight, the oxygen comes from the ambient air and if the oxygen content is lower than the predetermined content, oxygen will then be introduced, with or without inert gas, to increase the oxygen content in the vat 2.

If the vat 2 is airtight and the oxygen content is lower than the predetermined content, oxygen will then be introduced into the vat 2, with or without inert gas, to increase the oxygen content in the vat 2.

If the vat 2 is airtight and the oxygen content is greater than the predetermined content, inert gas will then be introduced into the vat 2 to lower the oxygen content in the vat 2.

The inert gas may be a pure inert gas or a mixture of inert gases.

In the remainder of the description, supply of gas to the vat 2 will mean that either inert gas or a mixture of inert gas and oxygen or oxygen is introduced, depending on the oxygen content present in the vat 2 relative to the predetermined content.

The operating method is as follows.

The olive paste will be introduced in conventional manner into the vat 2 to be kneaded therein.

During the kneading process, the oxygen concentration detecting probes 3 detect the oxygen concentration in the vat 2 and the data is then sent to the control unit 5 via the connection wires 4.

Depending on the oxygen concentration which has been programmed into the control unit 5, the latter controls the opening or closing of the general supply valve 8, to allow the supply of gas to the vat 2 and to achieve the predetermined oxygen content. During kneading, the lower supply value 9 is closed to prevent the paste from penetrating into the lower supply pipe 12 and gas is then supplied via the upper supply pipe 11.

With this method, it is always ensured that the optimum quantity of oxygen required to allow the enzymes to act is present while oxidation of the polyphenolic products and the tocopherols in the oil is avoided.

The oxygen content in the gaseous phase contained in the vat 2 is thus maintained at the predetermined value.

Prior to filling of the vat 2 with the paste, the vat 2 may be filled with gas to obtain a gaseous phase in the vat 2 in accordance with the predetermined oxygen content. Filling is advantageously performed via the lower supply pipe 12 due to the difference in mass between the oxygen and the inert gas, which will allow optimum filling of the vat 2 with the gas. This stage of filling the vat 2 with the gas prior to introduction of the paste is recommended in order to avoid oxidation during the filling stage. However, if filling is performed in such a manner that oxidation does not have time to come into effect before adjustment takes place, this stage may be avoided.

When the desired oxygen concentration is achieved in the vat 2, the lower supply valve 9 is closed manually or via the control unit 5, which receives data from the probes 3. Closure of the lower supply pipe 12 advantageously takes place at the level of the vat 2 to prevent any paste from being introduced into the lower supply pipe 12 during filling of the vat 2 with the paste.

The experimental results given below show the value of the method, in particular with regard to the content of polyphenols and tocopherols present in the oil resulting from use of the method according to the invention.

The following should be noted:
Sample A is a sample of an oil obtained from an olive paste treated using the conventional kneading method.
Sample B is a sample of an oil obtained from an olive paste treated according to the method of the invention, with an oxygen content in the vat 2 of 6%.

The results are listed in the Table below

Sample Test

| | A | B |
|---|---|---|
| Polyphenols (mg/kg) | 207 | 535 |
| Tocopherols (mg/kg) | 132 | 152 |

The marked increase in polyphenol and tocopherol contents between reference sample A and sample B produced using the method according to the invention will be noted.

The predetermined oxygen content is between 6% and 12% by volume.

Advantageously, the predetermined oxygen content is 6% by volume, which corresponds to an optimum enzyme activity rate.

The predetermined oxygen content depends on the olive paste treated. For each olive paste, a preferred oxygen content must be determined using various tests which make it possible to evaluate the polyphenol content of the oil as a function of the oxygen content present in the vat 2.

It goes without saying that the present invention is not limited to the examples and embodiments described and illustrated, but covers numerous variants accessible to the person skilled in the art.

Kneading with a screw device has been described, but any system may be used, such as systems using grinding wheels and scrapers.

The method may be used in continuous or discontinuous oil production processes.

In the invention described, the vat 2 is provided with a single upper supply pipe 11 and a single lower supply pipe 12, but to improve the distribution and homogenisation of the gaseous phase in the vat 2, a plurality of similar supply pipes may be positioned in the upper and lower parts of the vat 2.

What is claimed:

1) A method of kneading an olive paste in a vat (2) containing the olive phase and a gaseous phase, the method comprising:
a stage of filling the vat (2) with the olive paste;
a stage of kneading the past in the vat (2), the method being characterized in that it comprises a stage of maintaining the oxygen content of the gaseous phase at a predetermined value.

2) A method according to claim 1, characterized in that the stage of maintaining the oxygen content at the predetermined value is effected by injection of an inert gas or a mixture of inert gases.

3) A method according to claim 1, characterized in that the stage of maintaining the oxygen content at the predetermined value is effected by injection of oxygen.

4) A method according to claim 3, characterized in that injection of the inert gas and/or the oxygen is effected via the upper part of the vat (2).

5) A method according to claim 1, characterized in that it comprises a stage of filling the vat (2) with a gas until a gaseous phase is obtained in accordance with the predetermined value prior to the stage of filling the vat (2) with the olive paste.

6) A method according to claim 4, characterized in that the stage of filling the vat (2) with a gas is effected via the lower part of the vat (2).

7) A method according to claim 1 characterized in that monitoring of the oxygen content in the vat (2) during the stage of filling the vat (2) with a gas until a gaseous phase is obtained in accordance with the predetermined value and the stage of maintaining the oxygen content at the predetermined value is performed by a control unit (5) which determines whether or not to supply gas to the vat (2) as a function of the data which it receives from probes (3) for detecting the concentration of oxygen in the vat (2).

8) A method according to claim 1 characterized in that the predetermined value is between 6% and 12% by volume.

9) A method according to claim 8, characterized in that the predetermined value is 6% by volume.

10) A kneading device (1) for an olive paste suitable for carrying out a kneading method according to one of the preceding claims, the device comprising a vat (2) containing the paste to be kneaded and a gaseous phase, the device being characterized in that it comprises:
at least one oxygen concentration detecting probe (3) for measuring the oxygen concentration in the gaseous phase in the vat (2).
at least one gas supply pipe (11, 12) for supplying the vat (2) with gas;
a control unit (5) suitable for authorising or preventing the supply of gas to the vat (2) as a function of the data which it receives from probes (3) for detecting the concentration of oxygen in the vat (2).

11) A device according to claim 10, characterized in that it comprises a supply pipe (11) situated at the upper part of the vat (2) and suitable for supplying the vat (2) with gas to maintain the oxygen content at the predetermined value.

12) A device according to claim 10, characterized in that it comprises a supply pipe (12) situated at the lower part of the vat (2) and suitable for filling the vat (2) with a gas.

13) A device according to claim 10 characterized in that the gas is an inert gas or a mixture of inert gases.

14) A device according to claim 10 characterized in that the gas comprises oxygen.

15) A device according to claim 13 characterized in that the vat (2) is airtight.

16) A device according to claim 13, characterized in that the vat is not airtight.
